(19) United States
(12) Patent Application Publication
(10) Pub. No.: US 2007/0158084 A1
(43) Pub. Date: Jul. 12, 2007

(54) DEPLOYABLE FIRE EXTINGUISHING TOWEL

(75) Inventors: Douglas Schwartz, Montreal (CA); James W. Hilton, Grover, NC (US)

Correspondence Address: FULBRIGHT & JAWORSKI L.L.P., 600 CONGRESS AVE., SUITE 2400, AUSTIN, TX, 78701, US

(73) Assignee: PROTEKTOR INNOVATIONS INC., Quebec (CA)

(21) Appl. No.: 11/564,082

(22) Filed: Nov. 28, 2006

Related U.S. Application Data
(60) Provisional application No. 60/740,199, filed on Nov. 28, 2005.

(51) Int. Cl. A62C 11/00; A62C 13/00

(52) U.S. Cl. 169/30; 169/73; 169/72

(57) ABSTRACT

A fire extinguisher comprising a deployable flexible frame and a fire resistant material mounted to the flexible frame for being applied on a fire for extinguishment thereof. A fire extinguisher kit comprising the foregoing material that is mountable to the foregoing frame. The fire resistant material can be in the form of a towel that is mounted to the frame. Upon discovery of a fire, the fire extinguisher can be pulled out of its container and can immediately deploy, a handle allows the user to place the fire extinguisher over the burning object such as a pan, an additional material may hang from the frame to securely surround the object. When not in use the fire extinguisher may be foldably inserted into its container.

### CROSS-REFERENCE TO RELATED APPLICATIONS

This application claims the benefit of U.S. Provisional Application No. 60/740,199, filed Nov. 28, 2005, the contents of which are incorporated by reference.

### FIELD OF THE INVENTION

The present invention relates to a fire extinguisher. More specifically but not exclusively, the present invention relates to a deployable fire extinguishing towel.

### BACKGROUND OF THE INVENTION

Kitchen fires occur every eight minutes in North America and represent about 40% of all home fires, causing in excess of $148 million in property damage every year in addition to hurting an estimated 2,600 people of which 103 will die. Moreover, 30% of all fires in the United States find their origin in the kitchen. Additionally, about every 1.9 seconds there is a fire in the United States.

For emerging fires in the kitchen, a “Fire Extinguishing Towel” can extinguish the fire right at the source, before it expands and creates more damage and panic. Fire extinguishing towels quickly smother flaming deep fat fires and other small, accidental fires.

Fire Extinguishing Towels appear just like any other limp kitchen sized towel. However, these Fire Extinguishing Towels are impregnated with a non-flammable, odorless and colorless flame retardant chemical. Using such an impregnated Fire Extinguishing Towel will safely smother most any kitchen grease fire instantly, while extinguishing the flame and trapping damaging smoke. The fire will thus be extinguished and the flames and smoke will be kept from spreading.

The currently existing commercially available fire extinguishing towels suffer from several drawbacks.

A first problem with the currently existing commercially available fire extinguishing towels is that they are not instantly deployable. These fire extinguishing towels are typically advertised as quick opening and easy to use by virtue of being carefully folded in a handy package. This requires extra time and effort for their deployment, which is not available during a fire event. In addition, fumbling events by a nervous, panicked user, can be reasonably expected in a fire event, causing increased lag time in opening the package and unfolding the towel. This increases the risk of damage and injury unnecessarily.

A further problem with the currently existing commercially available fire extinguishing towels is that they require a person to closely approach a fire. To cover the fire with the fire extinguishing towel, the user must get very close to the fire, such that the bottom of the towel is located just before the area of the fire. The user's arms must typically pass over the fire for the towel to reach the back of the fire. Only this way can the towel be accurately positioned over the fire. It is evident that the closer one gets to a fire, the greater the risk of injury, both from the fire and the fire flash.

A further problem with the currently existing commercially available fire extinguishing towels is that they are not easy to use. Typical instructions for fire extinguishing towels are complex. Manufacturers will usually very strongly recommend that the procedure for using the towel be perfected before a fire event and that the procedure be practiced regularly. This frequent use of the towel will adversely affect the towel from properly functioning in case of a fire. Furthermore, the possibility of properly using the towel is further reduced in situation of panic in which one must act swiftly. In general, the following steps are required to operate conventional fire extinguishing towels:
a) removing the fire extinguishing towel from its envelope or package by grasping the two provided protruding tags and pulling;
b) grasping one edge of the blanket near a comer with each hand, the thumbs should be on one side of the blanket nearest the body and the fingers should be on the opposite side of the blanket.(i.e. palms downward and away);
c) turning palms towards each other and continue turning the hands in that direction until the palms are facing upwards;
d) lifting arms so that the weight of the blanket is on the tips of the fingers;
e) turning hands (fingers still pointing to the ceiling) such that the palms are facing the fire while a section of the blanket is curling around to protect the hands;
f) keeping arms up so that the blanket shields the face;
g) standing partly side-on to the fire with one leg forward and the other back;
h) moving slowly and carefully towards the fire, while being careful not to look over the top of the blanket at the fire;
i) letting the fire extinguishing towel's bottom touch the side of the counter top or container; and
j) moving arms forward, carefully lower the blanket over the top of the fire (ex. container) without throwing the blanket over the fire.

Yet a further problem with the currently existing commercially available fire extinguishing towels is that when thrown at fires, they are rendered useless. The natural tendency when faced with the need to approach a fire is to keep away. As such, people will often opt to throw the fire extinguishing towel at the fire rather than to follow the complex operating instructions as recited hereinabove. When thrown at a fire, the probability of achieving the objective of evenly positioning the fire extinguishing towel over the fire is almost zero. Moreover, when thrown at a fire, the fire extinguishing towel will most often fail to function properly. In addition, a thrown towel will most likely flash the flaming grease making the fire larger, which is why typical instructions for the use of fire extinguishing towels urge the user not to throw the towel at the fire.

Yet a further problem with the currently existing commercially available fire extinguishing towels is that they expose the user to fire flash. Fire extinguishing towels are limp pieces of material. Limp materials move in a random and unpredictable pattern, offering no protection to the user from fire flash - a leading cause of significant burns, particularly in the event of deep grease stove top fires. The unpredictable pattern of the towel's motion is further agitated by the additional motion imparted by the nervous user's arm movement.

Yet a further problem with the currently existing commercially available fire extinguishing towels is that they require an object to hold them over a container. Since fire extinguishing towels are limp pieces of material, manufacturers typically instruct the user to place a metal tray or any other flat solid object on top of the towel over the mouth of the container. Otherwise the hot burning oil will tend to drip or spill out of the pan, thereby expanding the fire. This action requires additional attention to the fire, unnecessarily prolonging the user's exposure to flash fire injury.

Finally, a further problem with the currently existing commercially available fire extinguishing towels is that they often sag into the grease, creating a wick. Since fire extinguishing towels are limp pieces of material, they will tend to sag when placed over the fire. When placed over a fire, the towel will have a natural gravity induced tendency to sag and dip into the grease, thereby creating a very dangerous wicking effect that may ignite the towel, exposing the user to tremendous danger.

### OBJECTS OF THE INVENTION

A general non-limiting object of the invention is to provide deployable fire extinguishing towel being self deployable when removed from its container and being easy to use.

### SUMMARY OF THE INVENTION

In accordance with an aspect of the present invention there is provided a fire extinguisher comprising a frame and a fire resistant material mounted to the frame for being applied on a fire for extinguishment thereof.

In accordance with another aspect of the present invention there is provided a fire extinguisher kit comprising a frame and a fire resistant material mountable to the frame for being applied on a fire for extinguishment thereof.

The term “fire extinguishing towel” may include a towel having a deployable flexible frame or merely a towel without the frame depending on the context.

Other objects, features and advantages of the present invention will become apparent from the following detailed description. It should be understood, however, that the detailed description and the specific examples, while indicating illustrative embodiments of the invention, are given by way of illustration only, since various changes and modifications within the spirit and scope of the invention will become apparent to those skilled in the art from this detailed description.

Further, the present invention refers to a number of documents, the content of which are incorporated by reference.

### BRIEF DESCRIPTION OF THE FIGURES

In the Figures in which like elements are referenced by like references throughout and in which:

FIG. 1 is a top view of a deployable fire extinguisher according to an embodiment of the present invention;

FIG. 2 is a side elevational view of the deployable fire extinguisher of FIG. 1 as deployed over a pan;

FIG. 3 is a front cross sectional view of the fire extinguisher of FIG. 1 towel placed within a container in a folded position.

### DETAILED DESCRIPTION OF ILLUSTRATIVE EMBODIMENTS

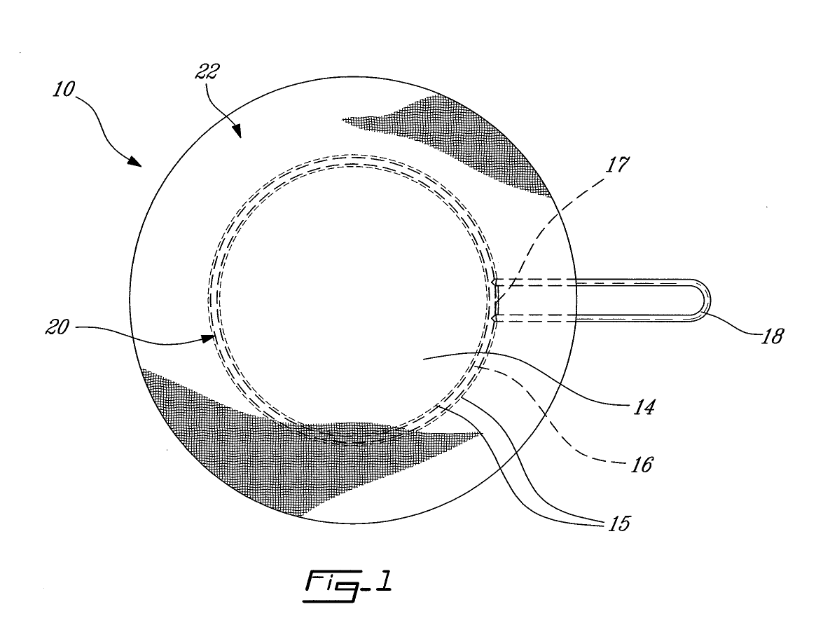

Referring more specifically to FIG. 1 of the appended drawings, the a fire extinguisher 10 in accordance with an embodiment, of the present invention comprises a deployable flexible frame 12 on which is mounted a fire resistant material 14 in the form of a towel. Stitched material 15 connects the fire resistant towel 14 to the frame 16. The towel 14 comprises an aperture 17 for providing a handle 18 extending from the deployable flexible frame 12 to extend therethrough. The fire resistant material defines an outer edge 20 from which hangs an additional material forming a security skirt or curtain 22.

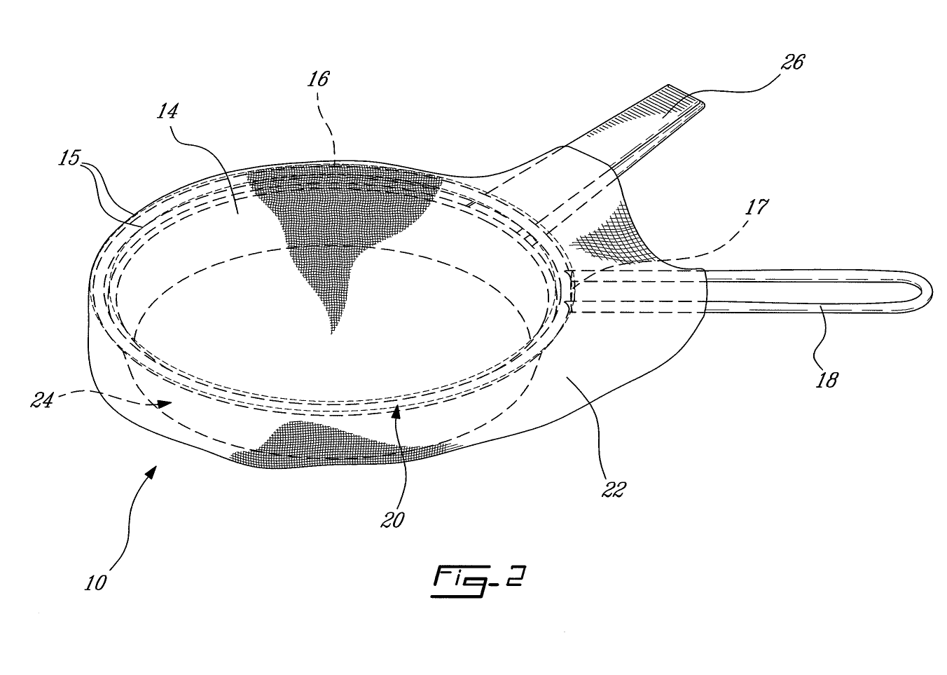

FIG. 2 shows the fire extinguisher 10 as deployed over a pan 24 having a handle 26. with the additional material forming a security skirt 22 around the pan 24

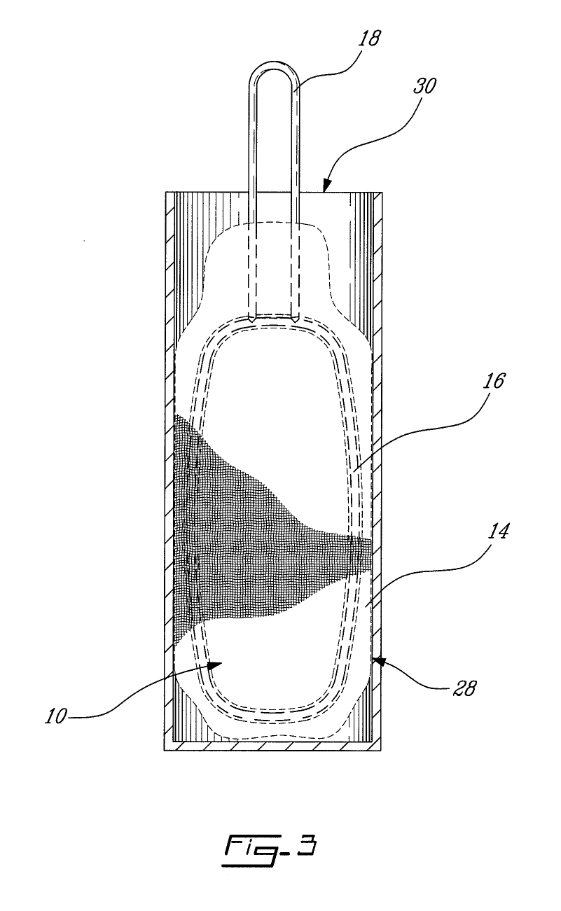

FIG. 3 shows the fire extinguisher 10 in folded position and placed within a container 28 that is a generally cylindrical elongate tube member having a receiving aperture 30.

Although not specifically shown in the appended drawings, the fire resistant towel 14 is composed of two layers of fire retardant fabric that are sewn together in a circular pattern defining an inner gap therebetween, in which is inserted the flexible frame 12. A second stitching can be done once the flexible frame 12 is inserted between the two layers of fire retardant fabric.

In another non-limiting embodiment, the two layers of fire retardant material fabric 14 can be glued or otherwise adhered together to define the inner gap in which is to be inserted the flexible frame 16.

In another non-limiting embodiment, the fire resistant towel 14 is composed of a single layer of fire retardant fabric, glued or otherwise adhered or attached to the flexible frame 16.

Although not specifically shown in the appended drawings, the fire extinguisher 10 can be manufactured such that it comprises a flexible frame 16 on which is mounted a fire resistant towel 14.

The frame 14 by its generally circular shape, may easily be folded by a twisting motion that forms multiple coils for easy storage since such a folding reduces its surface while allowing automatic deployment.

The additional or excess fire resistant material 22 is used such that a curtain or skirt of material can be formed around an object such as a typical stovetop pot or pan 24, once the fire extinguishing towel 14 is positioned thereon.

In a non-limiting embodiment, the flexible frame 16 may be made of a resilient wire, or a spring-loaded wire or be made of two rigid half-frames interconnected by a pair of spring-loaded hinges.

The flexible frame 16 allows for the deployable fire extinguisher 10 to be conveniently folded and positioned in a container such as tube 28. Upon removal of the deployable fire extinguisher 10 from the container 28, the flexible frame 26 immediately self-deploys such that the towel 14 is ready for use.

Upon discovery of a stovetop fire, the fire extinguisher 10 according to an embodiment of the present invention is removed from its container 28 by pulling on handle 18. The fire extinguisher 10 can immediately self deploy upon removal from its container 28, forming, in an embodiment, a rigid circular frame 16 covered completely with fire retardant material 14. The material 14 is of appropriate size such as to cover a typical stovetop pot or pan 24. The fire extinguisher 10 has additional material 22 hanging from the frame 16 (which defined the outer edge 20 of the material 14) such as to form a curtain or skirt around the typical stovetop pot or pan 24 in order to protect the user from possible flames flashing back from the fire while covering it.

The fire extinguisher 10 is positioned over and on a burning stovetop pot or pan 24, using the handle 18. The handle 18 allows for the user to position the fire extinguisher 10 over the burning stovetop pot or pan 24 while maintaining a safe distance from the fire. Ideally, the user should not get to within a foot (about 0.3 meter) of the fire. The fire extinguisher 10 completely covers the burning stovetop pot or pan 24. The flexible yet rigid frame 16 of the fire extinguisher 10 ensures that the towel 14 remains positioned on top of the burning pot or pan 24, providing as tight a seal as a properly placed limp towel, thus blocking out any air that would otherwise continue to fuel the fire. Moreover, the rigidity of the frame 16 will prevent the towel 14 from sagging, eliminating any risk of a wick effect. The stove should be turned off and the fire extinguisher 10 should remain on the covered object 24 until it has completely cooled.

The fire extinguisher 10 according to the embodiment of the present described hereinabove has the following non-limiting advantages:
is instantly deployable;
allows the user to keep a safe distance from the fire to be extinguished, thus minimizing the risk of exposing the user to fire flash;
eliminates the need for users to practice or perfect procedures for using the towel before a fire event;
can be readily positioned over a burning object (i.e. typical stovetop pot or pan) without the need of any throwing motion;
minimizes the risk of exposure of the user to fire flash;
remains in place after being positioned on top of a burning pot or pan;
is non-sagging, eliminating any risk of a wick effect;
can be sufficiently compressed to be stored in proximity of a stove; and
can be readily folded and positioned in a container for easy deployment.

It is to be understood that the present invention is not limited in its application to the details of construction and parts illustrated in the accompanying drawings and described hereinabove. The invention is capable of other embodiments and of being practiced in various ways. It is also understood that the phraseology or terminology used herein is for the purpose of description and not limitation. Hence, although the present invention has been described hereinabove by way of certain embodiments thereof, it can be modified, without departing from the spirit, scope and nature of the subject invention as defined in the appended claims.

1. A fire extinguisher comprising:
a frame; and
a fire resistant material mounted to said frame for being applied on a fire for extinguishment thereof.

2. The fire extinguisher of claim 1, wherein said frame is deployable.

3. The fire extinguisher of claim 1, wherein said frame is flexible.

4. The fire extinguisher of claim 1, wherein said frame is resilient.

5. The fire extinguisher of claim 1, wherein said frame comprises a generally circular configuration.

6. The fire extinguisher of claim 1, wherein said frame comprises a resilient wire.

7. The fire extinguisher of claim 1, wherein said frame comprises a spring-loaded wire.

8. The fire extinguisher of claim 1, wherein said frame comprises two rigid half-frames interconnected by a pair of spring loaded hinges.

9. The fire extinguisher of claim 1, wherein said frame is foldable.

10. The fire extinguisher of claim 1, wherein said frame is so foldable as to provide for placing said fire extinguisher within an elongated container.

11. The fire extinguisher of claim 1, wherein said frame comprises a handle extending therefrom.

12. The fire extinguisher of claim 11, wherein said handle is mounted to said frame.

13. The fire extinguisher of claim 11, wherein said handle is integral to said frame.

14. The fire extinguisher of claim 1, wherein said fire resistant material comprises a towel.

15. The fire extinguisher of claim 1, wherein said fire resistant material comprises at least two layers of fire retardant material.

16. The fire extinguisher of claim 15, wherein said at least two layers of fire retardant material are attached together.

17. The fire extinguisher of claim 16, wherein said at least two layers of fire retardant material are glued together.

18. The fire extinguisher of claim 16, wherein said at least two layers of fire retardant material are sown together.

19. The fire extinguisher of claim 15, wherein said at least two layers of fire retardant material are attached to said frame.

20. The fire extinguisher of claim 15, wherein at least two layers of fire retardant material define an inner gap therebetween providing a space for said frame.

21. The fire extinguisher of claim 1, wherein said fire resistant material comprises an aperture for allowing a handle to extend therethrough.

22. The fire extinguisher of claim 1, wherein said fire resistant material comprises a generally circular configuration.

23. The fire extinguisher of claim 1, wherein said fire resistant material comprises an outer edge having a skirt hanging therefrom.

24. A fire extinguisher kit comprising:
a frame; and
a fire resistant material mountable to said frame for being applied on a fire for extinguishment thereof.

25. The fire extinguisher kit of claim 24, further comprising a container for receiving said fire resistant material and said frame.

26. The fire extinguisher kit of claim 25, wherein said container comprises an elongate generally cylindrical configuration.

27. The fire extinguisher kit of claim 24, wherein said frame is deployable.

28. The fire extinguisher kit of claim 24, wherein said frame is flexible.

29. The fire extinguisher kit of claim 24, wherein said frame is resilient.

30. The fire extinguisher kit of claim 24, wherein said frame comprises a generally circular configuration.

31. The fire extinguisher kit of claim 24, wherein said frame comprises a resilient wire.

32. The fire extinguisher kit of claim 24, wherein said frame comprises a spring-loaded wire.

33. The fire extinguisher kit of claim 24, wherein said frame comprises two rigid half-frames interconnected by a pair of spring loaded hinges.

34. The fire extinguisher kit of claim 24, wherein said frame is foldable.

35. The fire extinguisher kit of claim 25, wherein said frame is foldable so as to be received within said container.

36. The fire extinguisher kit of claim 24, wherein said frame comprises a handle extending therefrom.

37. The fire extinguisher kit of claim 36, wherein said handle is mounted to said frame.

38. The fire extinguisher kit of claim 36, wherein said handle is integral to said frame.

39. The fire extinguisher kit of claim 24, wherein said fire resistant material comprises a towel.

40. The fire extinguisher kit of claim 24, wherein said fire resistant material comprises at least two layers of fire retardant material.

41. The fire extinguisher kit of claim 40, wherein said at least two layers of fire retardant material are attached together.

42. The fire extinguisher kit of claim 40, wherein said at least two layers of fire retardant material are glued together.

43. The fire extinguisher kit of claim 40, wherein said at least two layers of fire retardant material are sown together.

44. The fire extinguisher kit of claim 40, wherein at least two layers of fire retardant material define an inner gap therebetween for receiving said frame.

45. The fire extinguisher kit of claim 24, wherein said fire resistant material comprises an aperture for allowing a handle to extend therethrough.

46. The fire extinguisher kit of claim 24, wherein said fire resistant material comprises a generally circular configuration.

47. The fire extinguisher kit of claim 24, wherein said fire resistant material comprises an outer edge having a skirt hanging therefrom.
